(19) United States
(12) Patent Application Publication
(10) Pub. No.: US 2014/0293888 A1
(43) Pub. Date: Oct. 2, 2014

(54) METHOD AND APPARATUS FOR SELECTING PRIMARY COMPONENT CARRIER BASED ON UE MOBILITY STATE AND CELL COVERAGE

(71) Applicant: Electronics and Telecommunications Research Institute, Daejeon-si (KR)

(72) Inventors: Sang Chul OH, Daejeon-si (KR); Kyung Sook KIM, Daejeon-si (KR); Sung Hyun MOON, Seoul (KR); Young Jick BAHG, Daejeon-si (KR); Byung Han RYU, Daejeon-si (KR)

(73) Assignee: Electronics and Telecommunications Research Institute, Daejeon-si (KR)

(21) Appl. No.: 14/086,203

(22) Filed: Nov. 21, 2013

(30) Foreign Application Priority Data
Mar. 27, 2013 (KR) 10-2013-0032974

(51) Int. Cl. H04W 72/04

(52) U.S. Cl. CPC H04W 72/0486; H04W 72/0453
USPC 370/329

(57) ABSTRACT

The present invention relates to a method of selecting, by an eNB, a PCC for UE in a multiple component carrier system. The method includes obtaining mobility state information about the UE and coverage information and load information about carriers managed by the eNB; determining whether or not a mobility state value of the UE is greater than a specific threshold based on the obtained mobility state information; and selecting the PCC based on the load information if, as a result of the determination, the mobility state value is greater than the specific threshold. In accordance with the present invention, a BS adaptively selects a PCC by taking the load state of a carrier (or cell), UE mobility velocity, and the coverage of each carrier (or cell) into consideration.

The instant application claims priority to Korean patent application number 10-2013-0032974 filed on Mar. 27, 2013, the entire disclosure of which is incorporated by reference herein.

### BACKGROUND OF THE INVENTION

1. Field of the Invention

The present invention relates to wireless communication and, more particularly, to a method and apparatus for selecting a primary component carrier in a multiple component carrier system.

2. Discussion of the Related Art

A multiple component carrier system means a wireless communication system capable of supporting a carrier aggregation. The carrier aggregation is technology in which fragmented small bands are efficiently used and one base station bundles a plurality of physically continuous or non-continuous bands in a frequency domain and freely uses the bundled bands on a larger band according to circumstances. The multiple component carrier system may also be called a multiple carrier system. The multiple component carrier system supports a plurality of Component Carriers (CCs) distinguished in a frequency domain. A CC includes an uplink CC used in uplink and a downlink CC used in downlink. A downlink CC and an uplink CC can be combined and used as one logical serving cell. Alternatively, only a downlink CC can be used as one logical serving cell.

In a multiple CC aggregation system, the selection of a Primary Component Carrier (PCC) is important. For example, if plurality of CCs having different coverages is aggregated and used, a problem in that a PCC is properly selected can have a great influence on system performance. If a PCC is randomly selected, User Equipment (UE) needs to configure a new PCC through a handover or handoff procedure when the UE deviates from the coverage of the PCC. Accordingly, if UE moves, the UE may have to frequently configure a new PCC through a handover procedure. This can have a bad influence on system performance due to unnecessary handover signaling. Furthermore, there are problems in that all Secondary Component Carriers (SCCs) dependent on a PCC need to be released when the PCC is changed and SCCs need to be configured again through handover after a new PCC is configured.

### SUMMARY OF THE INVENTION

An object of the present invention is to provide a method and apparatus for selecting a PCC.

Another object of the present invention is to select a PCC by taking a UE mobility state and a cell coverage into consideration.

Yet another object of the present invention is to select a PCC by taking a cell load, mobility velocity of UE, and a cell coverage into consideration.

Further yet another object of the present invention is to select a proper PCC when UE initially accesses a network.

Still yet another object of the present invention is to reduce unnecessary handover signaling.

In accordance with an aspect of the present invention, there is provided a method of selecting, by an eNB, a PCC for UE in a multiple component carrier system. The method includes obtaining mobility state information about the UE and coverage information and load information about carriers managed by the eNB, determining whether or not a mobility state value of the UE is greater than a specific threshold based on the obtained mobility state information, and selecting the PCC based on the load information if, as a result of the determination, the mobility state value is greater than the specific threshold.

In accordance with another aspect of the present invention, there is provided a method of selecting, by an eNB, a PCC for UE in a multiple component carrier system. The method includes obtaining mobility velocity information about the UE and coverage information and load information about carriers managed by the eNB, selecting a carrier having a smallest load from the carriers based on the obtained load information, determining whether or not the selected carrier is a carrier having a largest coverage based on the obtained coverage information, and selecting the selected carrier as the PCC if, as a result of the determination, the selected carrier is a carrier having the largest coverage from among the carriers.

In accordance with yet another aspect of the present invention, there is provided a method of selecting, by an eNB, a PCC for UE in a multiple component carrier system. The method includes selecting a CC 1 having a smallest load from the CC 1, a CC2, and a CC3 having different coverages, determining mobility velocity of the UE, and selecting the selected CC1 as the PCC if, as a result of the determination, the mobility velocity is smaller than a specific threshold.

### BRIEF DESCRIPTION OF THE DRAWINGS

FIG. 1 shows a wireless communication system to which the present invention is applied;

FIG. 2 shows an example of a protocol structure for supporting multiple component carriers to which the present invention is applied;

FIG. 3 shows an example of a frame structure for a multiple component carrier operation to which the present invention is applied;

FIG. 4 shows a linkage between a downlink component carrier and an uplink component carrier in a multiple component carrier system to which the present invention is applied;

FIG. 5 shows an example of several component carrier aggregations having different coverages in a wireless communication system according to the present invention;

FIG. 6 shows an example of a method of selecting a primary component carrier in a multiple component carrier system according to the present invention;

FIG. 7 shows another example of a method of selecting a primary component carrier in a multiple component carrier system according to the present invention; and

FIG. 8 shows a detailed embodiment of a method of selecting a primary component carrier in a multiple component carrier system according to the present invention.

### DETAILED DESCRIPTION OF THE EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in this specification, a wireless communication network is described as a target, and tasks performed over the wireless communication network can be performed in a process in which a system (e.g., a base station) managing the wireless communication network controls the wireless communication network and sends data or can be performed by a terminal that accesses the wireless communication network.

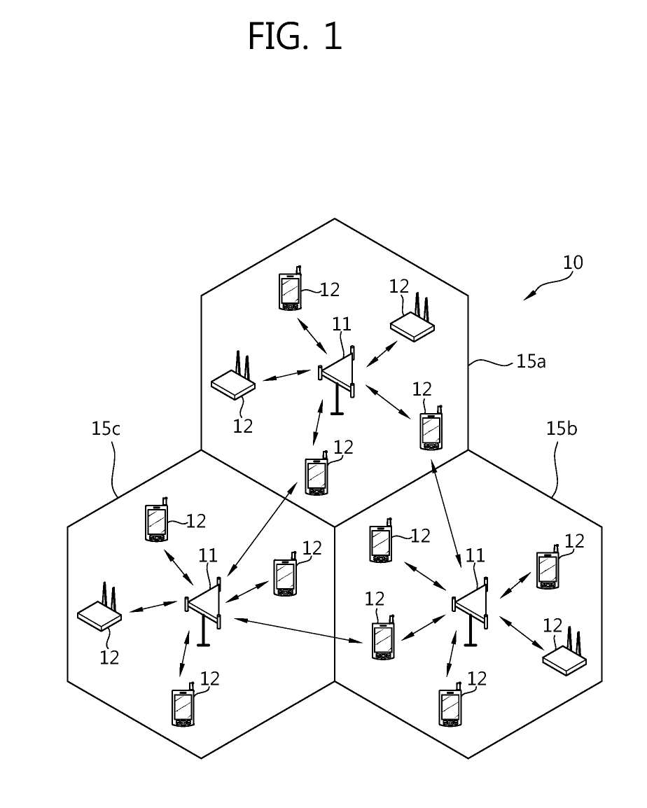

FIG. 1 shows a wireless communication system to which the present invention is applied.

Referring to FIG. 1, a plurality of the wireless communication systems 10 is widely deployed in order to provide various communication services, such as voice and packet data. The wireless communication system 10 includes one or more Base Stations (BS) 11. The BSs 11 provide communication services to specific cells 15a, 15b, and 15c. Each of the cells can be classified into a plurality of areas (called sectors).

User Equipment (UE) 12 can be fixed or mobile and can also be called another terminology, such as a Mobile Station (MS), a Mobile Terminal (MT), a User Terminal (UT), a Subscriber Station (SS), a wireless device, a Personal Digital Assistant (PDA), a wireless modem, or a handheld device. The BS 11 can also be called another terminology, such as an evolved-NodeB (eNodeB), a Base Transceiver System (BTS), an access point, a femto BS, a Home nodeB (HeNB), or a relay. The cell should be interpreted as a comprehensive meaning that indicates some area covered by the BS 11. The cell has a meaning that covers a variety of coverage areas, such as a mega cell, a macro cell, a micro cell, a pico cell, a femto cell, and a small cell.

Hereinafter, downlink refers to communication from the BS 11 to the UE 12, and uplink refers to communication from the UE 12 to the BS 11. In downlink, a transmitter can be part of the BS 11 and a receiver can be part of the UE 12. In uplink, a transmitter can be part of the UE 12 and a receiver can be part of the BS 11. Multiple access schemes applied to the wireless communication system are not limited. Various types of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier-FDMA (SC-FDMA), OFDM-FDMA, OFDM-TDMA, and OFDM-CDMA, can be used. Uplink transmission and downlink transmission can be performed in accordance with a Time Division Duplex (TDD) method using different times or a Frequency Division Duplex (FDD) method using different frequencies.

A Carrier Aggregation (CA) supports a plurality of carriers, and the CA is also called a spectrum aggregation or a bandwidth aggregation. An individual unit carrier aggregated by a CA is called a Component Carrier (hereinafter referred to as a ‘CC’). Each CC is defined by a bandwidth and a center frequency. A CA is introduced in order to support an increased throughput, prevent an increase of costs due to the introduction of wideband Radio Frequency (RF) devices, and guarantee compatibility with the existing systems. For example, if 5 CCs are allocated as the granularity of a carrier unit having a 20 MHz bandwidth, a maximum of a 100 MHz bandwidth can be supported.

A CA can be divided into a contiguous CA performed between continuous CCs and a non-contiguous CA performed between non-contiguous CCs in a frequency domain. The number of carriers aggregated in downlink can be set differently from the number of carriers aggregated in uplink. A case where the number of downlink CCs is equal to the number of uplink CCs is called a symmetric aggregation, and a case where the number of downlink CCs is different from the number of uplink CCs is called an asymmetric aggregation.

CCs can have different sizes (i.e., bandwidths). For example, assuming that 5 CCs are used to form a 70 MHz band, a resulting configuration can be, for example, 5 MHz CC (carrier #0)+20 MHz CC (carrier #1)+20 MHz CC (carrier #2)+20 MHz CC (carrier #3)+5 MHz CC (carrier #4).

Hereinafter, a multiple component carrier system refers to a system which supports a CA. In a multiple component carrier system, a contiguous CA or a non-contiguous CA or both can be used. Furthermore, either a symmetrical aggregation or an asymmetrical aggregation can be used.

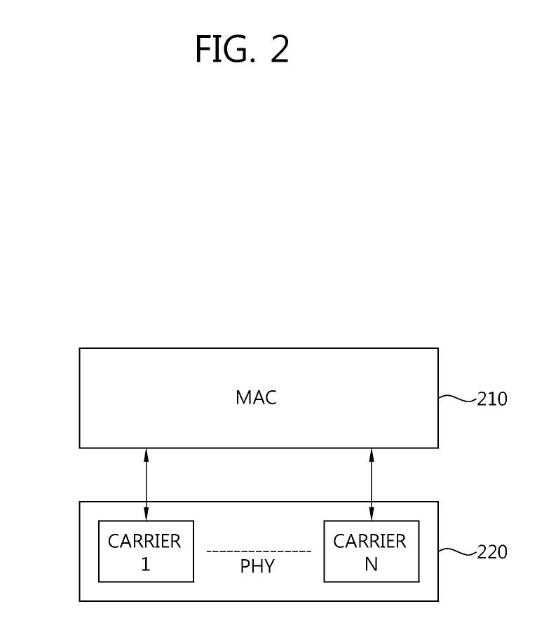

FIG. 2 shows an example of a protocol structure for supporting multiple component carriers to which the present invention is applied.

Referring to FIG. 2, a common Medium Access Control (MAC) entity 210 manages a physical layer 220 using a plurality of carriers. An MAC management message that is transmitted through a specific carrier can be applied to other carriers. That is, the MAC management message is a message capable of controlling other carriers including the specific carrier. The physical layer 220 can operate according to a time division duplex (TDD) method and/or a frequency division duplex (FDD) method.

Several physical control channels are used in the physical layer 220. A physical downlink control channel (PDCCH) informs UE of the resource assignment of a paging channel (PCH) and a downlink shared channel (DL-SCH) and Hybrid Automatic Repeat reQuest (HARQ) information related to a DL-SCH. The PDCCH can carry an uplink grant that informs UE of resource assignment for UL transmission. The DL-SCH is mapped to a physical downlink shared channel (PDSCH). A physical control format indicator channel (PCFICH) informs UE of the number of OFDM symbols used in PDCCHs, and the PCFICH is transmitted in each subframe. A physical hybrid ARQ indicator channel (PHICH) carries an HARQ ACK/NAK signal as a response to UL transmission. A physical uplink control channel (PUCCH) carries an HARQ ACK/NAK signal for DL transmission, a scheduling request, and UL control information, such as a Channel Quality Indicator (CQI). A physical uplink shared channel (PUSCH) carries an uplink shared channel (UL-SCH). A physical random access channel (PRACH) carries an RA preamble.

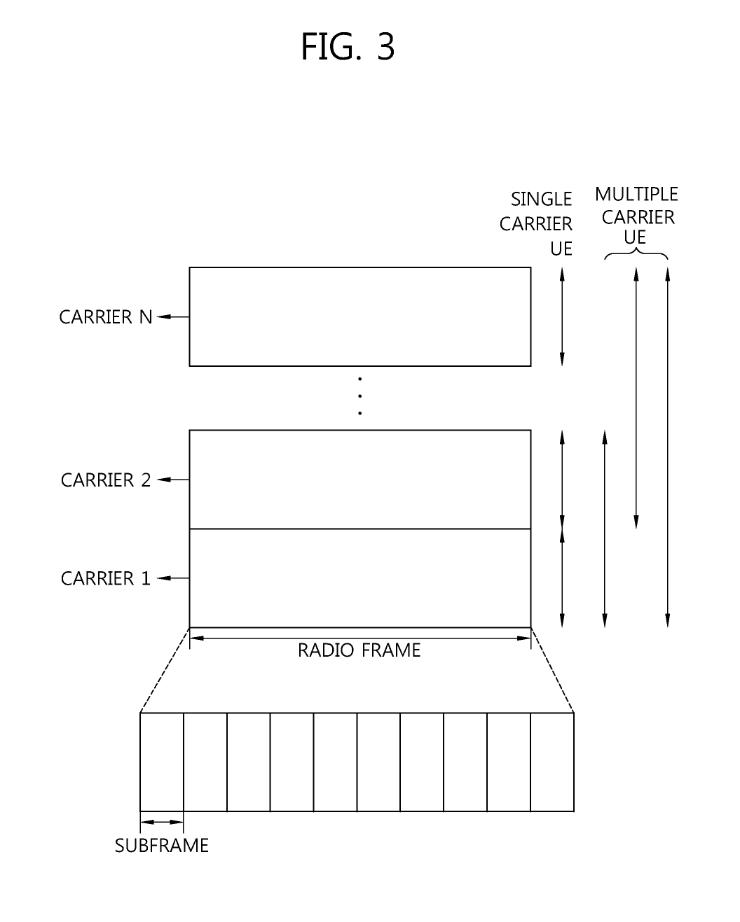

FIG. 3 shows an example of a frame structure for a multiple CC operation to which the present invention is applied.

Referring to FIG. 3, a frame includes 10 subframes. The subframe includes a plurality of OFDM symbols. Each CC can have its own control channel (e.g., a PDCCH). Multiple CCs may be contiguous to each other or may not be contiguous to each other. UE can support one or more carriers depending on its capabilities.

A CC can be divided into a Primary Component Carrier (PCC) and a Secondary Component Carrier (SCC) depending on whether the CC has been activated or not. A PCC is a carrier always activated, and an SCC is a carrier activated or deactivated according to specific conditions. Activation refers to a state in which the transmission or reception of traffic data is being performed or a state in which the transmission or reception of traffic data is in a ready state. Deactivation refers to a state in which the transmission or reception of traffic data is impossible, but measurement or the transmission and reception of minimum information is possible. UE may use only one PCC or may use one or more SCCs along with a PCC. A BS may allocate a PCC or an SCC or both to UE.

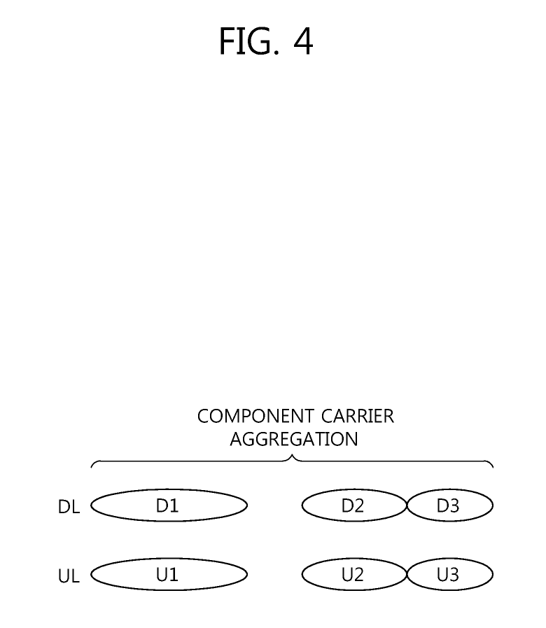

FIG. 4 shows a linkage between a downlink CC and an uplink CC in a multiple component carrier system to which the present invention is applied.

Referring to FIG. 4, in downlink, for example, downlink CCs D1, D2, and D3 are aggregated, and in uplink, uplink CCs U1, U2, and U3 are aggregated. Here, Di is an index of a downlink CC, and Ui is an index of an uplink CC (i=1, 2, 3). Each index does not comply with order of a corresponding CC or the location of a frequency band of a corresponding CC.

Meanwhile, at least one downlink CC can be configured as a PCC, and the remaining CCs can be configured as SCCs. Furthermore, at least one uplink CC can be configured as a PCC, and the remaining CCs can be configured as SCCs. For example, D1 and U1 can be PCCs, and D2, U2, D3, and U3 can be SCCs.

Here, an index of the PCC can be set to 0, and one of the remaining natural numbers can be an index of the SCC. For example, an index of a downlink/uplink CC can be set to be the same as that of a CC (or a serving cell) including the downlink/uplink CC. For another example, only an index of a CC or an index of an SCC can be set, and an index of an uplink/uplink CC included in the CC or the SCC may not be present. The CC index can be represented by a serving cell index, and a serving cell index including a primary serving cell and a secondary serving cell for only secondary serving cells can be separately defined.

In an FDD system, a DL CC and an UL CC can be linked in a one-to-one way. For example, each of D1 and U1, D2 and U2, and D3 and U3 can be linked in a one-to-one way. UE performs a linkage between the DL CCs and the UL CCs based on system information transmitted through a logical channel BCCH or a UE-dedicated RRC message transmitted through a DCCH. This connection is called System Information Block1 (SIB1) connection or SIB2 connection. Each linkage may be set up in a cell-specific way or in a UE-specific way. For example, a PCC can be configured in a cell-specific way, and an SCC can be configured in a US-specific way.

Here, the DL CC and the UL CC can have not only a 1:1 linkage, but also a 1:n or n:1 linkage.

A primary serving cell means one serving cell that provides security input and NAS mobility information in an RRC establishment or re-establishment state. One or more cells can be configured to form a set of serving cells along with a primary serving cell depending on the capabilities of UE. The one or more cells are called secondary serving cells.

Accordingly, a set of serving cells configured for one UE can include only one primary serving cell or can include one primary serving cell and one or more secondary serving cells.

A DL CC corresponding to a primary serving cell is called a downlink PCC (DL PCC), and a UL CC corresponding to a primary serving cell is called an uplink PCC (UL PCC). Furthermore, in downlink, a CC corresponding to a secondary serving cell is called a downlink SCC (DL SCC). In uplink, a CC corresponding to a secondary serving cell is called an uplink SCC (UL SCC). Only one DL CC or both a DL CC and a UL CC can correspond to one serving cell.

Accordingly, in a carrier system, a concept that communication between UE and a BS is performed through a DL CC or a UL CC is the same as a concept that communication between the UE and the BS is performed through a serving cell. For example, in a method of performing a random access procedure according to the present invention, a concept that UE sends a preamble using a UL CC can be considered to be the same concept that the UE sends the preamble using a primary serving cell or a secondary serving cell. Furthermore, a concept that UE receives downlink information using a DL CC can be considered to be the same concept that the UE receives the downlink information using a primary serving cell or a secondary serving cell.

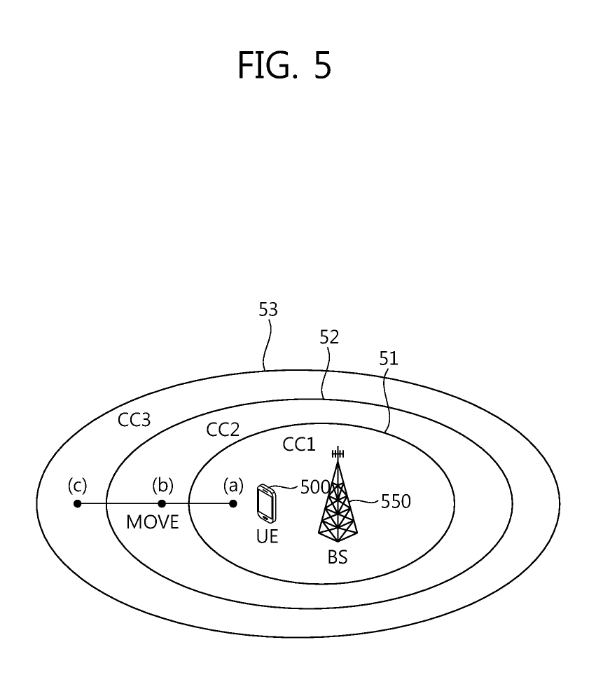

FIG. 5 shows an example of several CC aggregations having different coverages in a wireless communication system according to the present invention.

Referring to FIG. 5, UE 500 supports multiple CCs. For example, the UE can support a CC1 51, a CC2 52, and a CC3 53. If the UE 500 attempts connection to a network at a location (a), the UE 500 can use all the CC1 51, the CC2 52, and the CC3 53 allocated by a BS 550. One of the CC1 51, the CC2 52, and the CC3 53 needs to be configured as a Primary Component Carrier (PCC), and the remaining CCs can be configured as Secondary Component Carriers (SCCs). For example, the CC1 51 can be configured as a PCC. In this case, the CC2 52 and the CC3 53 can be configured as SCCs. A PCC can carry control information about SCCs. In accordance with the 3^{rd} Generation Partnership Project (3GPP) standard, a PCC can be changed only through a handover procedure. In this case, all SCCs already configured in UE must be released. After a new PCC is configured in the UE 500, SCCs can be configured (or reconfigured). Accordingly, the selection of a PCC in a multiple component carrier system is important.

If the UE 500 moves to a location (b) after the CC1 51 is allocated to the UE 500 as a PCC at the initial location (a), the UE 500 has to perform a handover procedure so that a PCC is allocated to the UE 500 again because the UE 500 gets out of the coverage of the CC1 51. If the UE 500 moves to a location (c) although the CC2 52 has been allocated to the UE 500 as a PCC at the location (b), the UE 500 has to perform a handover procedure so that a PCC is allocated to the UE 500 again because the UE 500 gets out of the coverage of the CC2 52. Furthermore, there is a problem in that SCCs need to experience a configuration (or reconfiguration) process after all the SCCs are released whenever the UE 500 performs a handover procedure. This can cause an unnecessary load, with the result that a system is subject to a bad influence.

Hereinafter, the present invention proposes a method of efficiently selecting a PCC by taking a UE mobility state (e.g., mobility velocity) and a cell coverage into consideration.

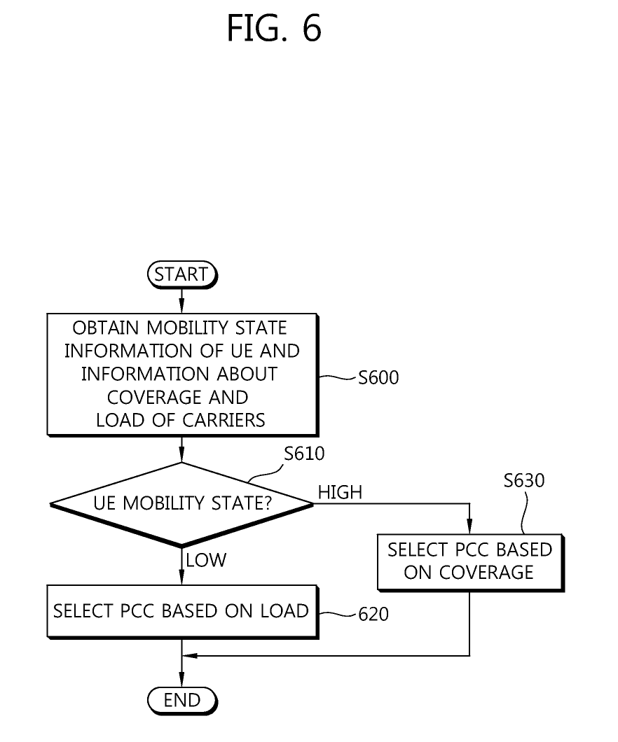

FIG. 6 shows an example of a method of selecting a PCC in a multiple component carrier system according to the present invention.

Referring to FIG. 6, a BS obtains mobility state information about UE, such as mobility velocity, and information about the coverage and load of carriers that are managed by the BS at step S600. The BS may autonomously determine a UE mobility state, or the UE may estimate a UE mobility state, such as velocity, and send the estimated UE mobility state to the BS.

The BS determines whether the UE mobility state is ‘high’ or ‘low’ based on the obtained UE mobility state information at step S610. For example, the BS may determine that the UE mobility state is ‘high’ when UE mobility velocity is greater than a specific threshold, and the BS may determine that the UE mobility state is ‘low’ when UE mobility velocity is smaller than a specific threshold.

If, as a result of the determination at step S610, it is determined that the UE mobility state is ‘low’, the BS selects a PCC based on a load at step S620. For example, the BS can select a carrier having the smallest load as a PCC. For another example, the BS can select one of carriers, having a load of a specific level or lower, as a PCC. In this case, since a mobility state, such as UE mobility velocity, is low, the BS can select a PCC by taking the load balancing of the carriers into consideration rather than the coverage of each carrier and provide smooth wireless communication service to the UE.

If, as a result of the determination at step S610, it is determined that the UE mobility state is ‘high’, the BS selects a PCC based on a coverage at step S630. For example, the BS can select a carrier, having the largest coverage, as a PCC. Meanwhile, although a carrier having the largest coverage has been selected as a PCC, the BS may select a carrier having the next largest coverage as a PCC if the selected carrier is in an overload state. For another example, the BS can select one of carriers, having a coverage of a specific level or higher, as a PCC. In this case, since a mobility state, such as UE mobility velocity, is high, the BS can select a PCC by taking the coverage of each carrier into consideration rather than the load balancing of the carriers in order to prevent the frequent handover of the UE.

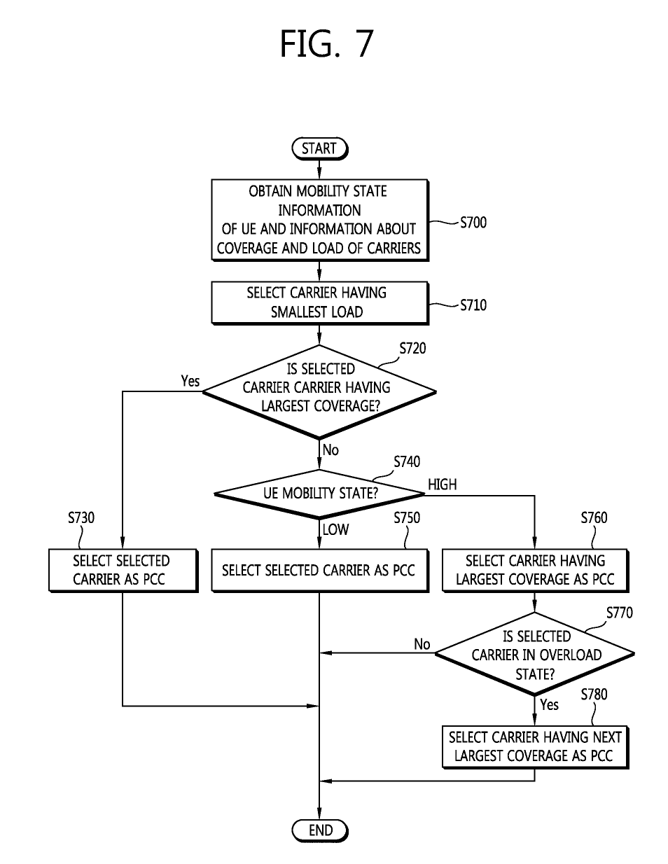

FIG. 7 shows another example of a method of selecting a PCC in a multiple component carrier system according to the present invention.

A BS, a BS obtains UE mobility velocity information, such as mobility velocity of UE, and information about the coverage of carriers and a load that are managed by the BS at step S700. The BS may autonomously determine a UE mobility state, or the UE may estimate a UE mobility state, such as velocity, and send the estimated UE mobility state to the BS.

The BS selects a carrier having the smallest load based on the obtained load information at step S710. In other words, the BS selects a carrier, having the smallest load, from carriers that can be managed by the BS and aggregated by the UE.

The BS determines whether or not the selected carrier is a carrier having the largest coverage based on the obtained coverage information at step S720. In other words, the BS determines whether or not a carrier selected from carriers that can be managed by the BS and aggregated by the UE is a carrier having the largest coverage.

If, as a result of the determination at step S720, it is determined that the selected carrier is a carrier having the largest coverage, the BS selects the selected carrier as a PCC at step S730.

If, as a result of the determination at step S720, it is determined that the selected carrier is not a carrier having the largest coverage, the BS determines whether the UE mobility velocity is ‘high’ or ‘low’ based on the obtained UE mobility velocity information at step S740. For example, the BS may determine that the UE mobility velocity is ‘high’ when the UE mobility velocity is greater than a specific threshold, and the BS may determine that the UE mobility velocity is ‘low’ when the UE mobility velocity is smaller than a specific threshold.

If, as a result of the determination at step S740, it is determined that the UE mobility velocity is ‘low’, the BS selects the selected carrier as a PCC at step S750.

If, as a result of the determination at step S740, it is determined that the UE mobility velocity is ‘high’, the BS selects a carrier having the largest coverage as a PCC at step S760. In this case, the BS determines whether or not the selected carrier having the largest coverage is in an overload state at step S770.

If, as a result of the determination at step S770, it is determined that the selected carrier having the largest coverage is in an overload state, the BS selects a carrier having the next largest coverage as a PCC at step S780. If, as a result of the determination at step S770, it is determined that the selected carrier having the largest coverage is not in an overload state, the current selected carrier (i.e., the carrier having the largest coverage) becomes a PCC.

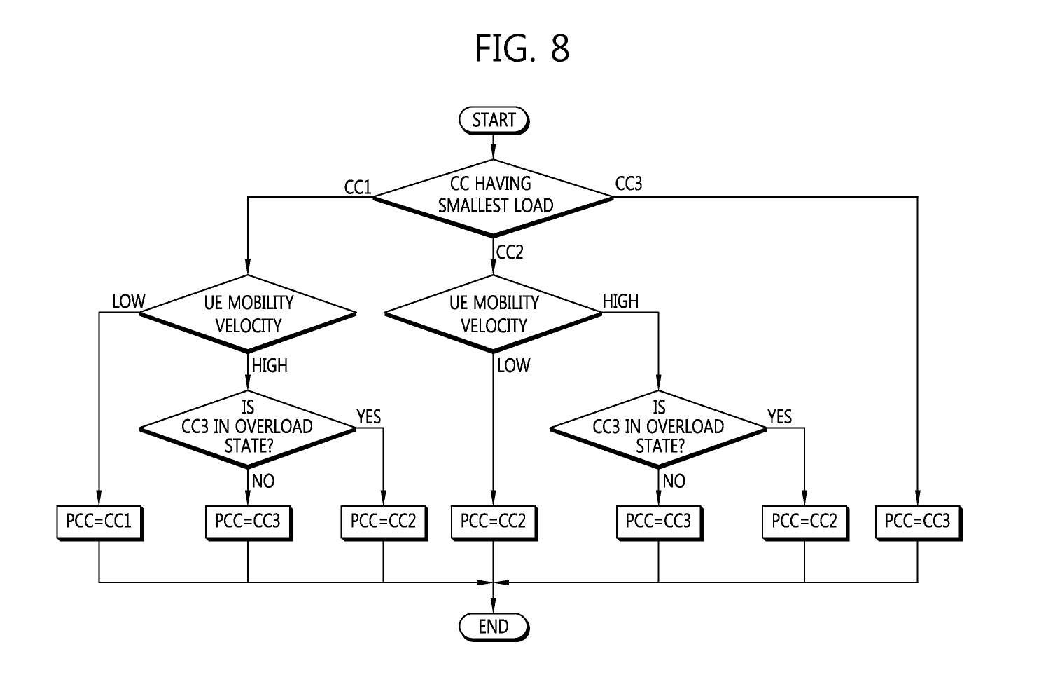

FIG. 8 shows a detailed embodiment of a method of selecting a PCC in a multiple component carrier system according to the present invention. FIG. 8 shows an example that may be applied to the aforementioned carrier (or cell) deployment structure of FIG. 5.

Referring to FIGS. 6 and 8, a BS selects a CC having the smallest load from the CC1, the CC2, and the CC3. The BS may select the CC when UE accesses a network or accesses a network again or may select the CC when UE is connected to a network through a handover procedure.

For example, if the BS selects the CC1 as a CC having the smallest load, the BS determines whether UE mobility velocity is high or low. If, as a result of the determination, the UE mobility velocity is low, the BS selects the CC1 as a PCC. If, as a result of the determination, the UE mobility velocity is high, the BS determines whether or not the CC3 is in an overload state. If, as a result of the determination, the CC3 is not in an overload state, the BS selects the CC3 as a PCC. If, as a result of the determination, the CC3 is in an overload state, the BS selects the CC2 as a PCC.

For another example, if the BS selects the CC2 as a CC having the smallest load, the BS determines whether UE mobility velocity is high or low. If, as a result of the determination, the UE mobility velocity is low, the BS selects the CC2 as a PCC. If, as a result of the determination, the UE mobility velocity is high, the BS determines whether or not the CC3 is in an overload state. If, as a result of the determination, the CC3 is not in an overload state, the BS selects the CC3 as a PCC. If, as a result of the determination, the CC3 is in an overload state, the BS selects the CC2 as a PCC.

For yet another example, if the BS selects the CC3 as a CC having the smallest load, the BS selects the CC3 as a PCC.

As described above, the BS adaptively selects a PCC by taking the load state of a carrier (or cell), UE mobility velocity, and the coverage of each carrier (or cell) into consideration. Accordingly, load balancing can be achieved, and a load due to the unnecessary handover and handover signaling of UE can be reduced. Furthermore, SCCs can be prevented from being configured (or reconfigured) after all the SCCs are released due to the frequent change of a PCC. As a result, the entire system performance can be improved.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A method of selecting, by an eNB, a Primary Component Carrier (PCC) for User Equipment (UE) in a multiple component carrier system, the method comprising:
obtaining mobility state information about the UE and coverage information and load information about carriers managed by the eNB;
determining whether or not a mobility state value of the UE is greater than a specific threshold based on the obtained mobility state information; and
selecting the PCC based on the load information if, as a result of the determination, the mobility state value is greater than the specific threshold.

2. The method of claim 1, further comprising selecting the PCC based on the coverage information if, as a result of the determination, the mobility state value is smaller than the specific threshold.

3. The method of claim 1, wherein selecting the PCC based on the load information comprises selecting a carrier having a smallest load, from among the carriers managed by the eNB, as the PCC.

4. The method of claim 2, wherein selecting the PCC based on the coverage information comprises selecting a carrier having a largest coverage, from among the carriers managed by the eNB, as the PCC.

5. The method of claim 4, wherein a carrier having a next largest coverage is selected as the PCC if the carrier having the largest coverage is in an overload state.

6. A method of selecting, by an eNB, a Primary Component Carrier (PCC) for User Equipment (UE) in a multiple component carrier system, the method comprising:
obtaining mobility velocity information about the UE and coverage information and load information about carriers managed by the eNB;
selecting a carrier having a smallest load from the carriers based on the obtained load information;
determining whether or not the selected carrier is a carrier having a largest coverage based on the obtained coverage information; and
selecting the selected carrier as the PCC if, as a result of the determination, the selected carrier is a carrier having the largest coverage from among the carriers.

7. The method of claim 6, further comprising:
determining whether the mobility velocity of the UE is greater than a specific threshold based on the obtained mobility velocity information if, as a result of the determination, the selected carrier is not a carrier having the largest coverage from among the carriers; and
selecting the selected carrier as the PCC if, as a result of the determination, the mobility velocity of the UE is smaller than the specific threshold.

8. The method of claim 7, further comprising selecting the carrier having the largest coverage, from among the carriers, as the PCC if, as a result of the determination, the mobility velocity of the UE is greater than the specific threshold.

9. The method of claim 8, further comprising determining whether or not the carrier, having the largest coverage and now selected as the PCC, is in an overload state.

10. The method of claim 9, further comprising selecting a carrier having a next largest coverage as the PCC if, as a result of the determination, the carrier having the largest coverage and now selected as the PCC is in the overload state.

11. A method of selecting, by an eNB, a Primary Component Carrier (PCC) for User Equipment (UE) in a multiple component carrier system, the method comprising:
selecting a CC 1 having a smallest load from the CC 1, a CC2, and a CC3 having different coverages;
determining mobility velocity of the UE; and
selecting the selected CC1 as the PCC if, as a result of the determination, the mobility velocity is smaller than a specific threshold.

12. The method of claim 11, further comprising selecting the CC3 having a largest coverage as the PCC if, as a result of the determination, the mobility velocity is greater than the specific threshold.

13. The method of claim 12, further comprising:
determining whether or not the CC3 is in an overload state; and
selecting the CC2, having a largest coverage next to the CC3, as the PCC if, as a result of the determination, the CC3 is in an overload state.
